(19) United States
(12) Patent Application Publication
(10) Pub. No.: US 2014/0354830 A1
(43) Pub. Date: Dec. 4, 2014

(54) SYSTEM AND METHOD FOR ADDING SCALE TO PHOTOGRAPHIC IMAGES

(71) Applicant: Littleton Precision, LLC, Littleton, NH (US)

(72) Inventors: GUY SCHAFER, Dalton, NH (US); Scott Schafer, Littleton, NH (US)

(73) Assignee: Littleton Precision, LLC, Littleton, NH (US)

(21) Appl. No.: 14/263,052

(22) Filed: Apr. 28, 2014

Related U.S. Application Data
(60) Provisional application No. 61/830,213, filed on Jun. 3, 2013.

(51) Int. Cl. H04N 1/00

(52) U.S. Cl. CPC H04N 1/00241; H04N 1/00135; H04N 1/00148; H04N 1/00167; H04N 1/00251; H04N 1/00347; H04N 1/00127; H04N 2101/00
USPC 348/207.1

(57) ABSTRACT

The system and method for applying a scale to a digital photograph. The system and method of applying a scale to a digital photograph providing standardized, scaled images for medical records without breaking the sterile field. A scaled-grid overlay is superimposed on an image of a wound or other external feature, thus preserving the field of sterility and facilitating ongoing documentation of the status of the wound or other feature of interest. The system and method comprise a laser, a camera, a scanner, and a central processor to collect, process, and store data relating to scaled digital photographs

### CROSS REFERENCE TO RELATED APPLICATIONS

This Application claims the benefit of U.S. Provisional Application No. 61/830,213, filed June. 3, 2013, the content of which is incorporated by reference herein in its entirety.

### FIELD OF THE INVENTION

This invention relates to photographic imagery systems, and more particularly to scaled elements associated with images used in various fields of endeavor including medical and non-medical applications.

### BACKGROUND OF THE INVENTION

Current medical procedures, including those for monitoring lymphedemas, require laying a physical scale element (e.g., a ruler, a coin, a pencil, or the like) near the feature, thus allowing its size to be determined by visual comparison. This method breaks the sterile field, potentially exposing a patient to infection. The current methods also require significant input from the user, who must label, date, and save the image before any further analysis and/or measurement of the feature can occur. Furthermore, scale elements can vary significantly from image to image, making accurate comparison among a series of images difficult. In contrast, the system and method of the present invention provides standardized, scaled images for medical records without breaking the sterile field. A scaled-grid overlay is superimposed on an image of a wound or other external feature, thus preserving the field of sterility and facilitating ongoing documentation of the status of the wound or other feature of interest.

### SUMMARY OF THE INVENTION

It has been recognized that there is currently no other measurement and documentation system that fulfills the criteria of preserving the field of sterility and facilitating ongoing documentation of the status of a wound or other feature of interest. Because the system and method of the present invention uses a laser distance-meter to identify the distance to a feature that is being photographed, the feature remains sterile. Additionally, by associating an image with a standard, overlaid length-measurement scale created by the system of the present invention, a user can quickly and more accurately determine and document the size of a wound, lesion, or other feature. Unlike current solutions, this system automatically documents and records physical features by measuring the distance to the feature and using this distance to determine its size accurately in millimeters, inches, or the like and then stores the information as an electronic file.

One aspect of the present invention is a system for applying a scale to a digital photograph, comprising a scanner, wherein the scanner is configured to collect data about a subject in a digital photograph; a digital camera, wherein the digital camera is configured to capture digital photographs of the subject; and a laser adjacent to the digital camera, wherein the laser determines the distance from the subject and uses the distance to apply a scale to the digital photograph; a central processor in electrical communication with the scanner, the laser, and the digital camera, wherein the processor collects, processes, and stores data relating to the digital photographs.

One embodiment of the system for applying a scale to a digital photograph is wherein the data about the subject in a digital photograph relates to a patient.

One embodiment of the system for applying a scale to a digital photograph is wherein the data about the subject in a digital photograph comprises a patient identification number, date, time, and body part.

One embodiment of the system for applying a scale to a digital photograph is wherein the central processor can be used to select the unit of measurement and the type of scale to be applied to the digital photograph.

One embodiment of the system for applying a scale to a digital photograph further comprises an articulating arm connected to the digital camera.

One embodiment of the system for applying a scale to a digital photograph is wherein the central processor is a laptop configured to run specialized instructions.

One embodiment of the system for applying a scale to a digital photograph is wherein the data about the subject in a digital photograph relates to non-medical applications such as online sales, site mapping, insurance documentation, digitized inventory, and forensics.

Another aspect of the invention is a method of applying a scale to a digital photograph, comprising providing a scanner, wherein the scanner is configured to collect data about a subject in a digital photograph; providing a digital camera, wherein the digital camera is configured to capture digital photographs of the subject in a digital photograph; and providing a laser adjacent to the digital camera; determining, with the laser, the distance from the subject; applying a scale to the digital photograph; providing a central processor in electrical communication with the scanner, the laser, and the digital camera; collecting data relating to the digital photographs; processing data relating to the digital photographs; and storing data relating to the digital photographs.

One embodiment of the method for applying a scale to a digital photograph is wherein the data about the subject in a digital photograph relates to a patient.

One embodiment of the method for applying a scale to a digital photograph is wherein the data about the subject in a digital photograph comprises a patient identification number, date, time, and body part.

One embodiment of the method for applying a scale to a digital photograph is wherein the central processor can be used to select the unit of measurement and the type of scale to be applied to the digital photograph.

One embodiment of the method for applying a scale to a digital photograph further comprises providing an articulating arm connected to the digital camera.

One embodiment of the method for applying a scale to a digital photograph wherein the central processor is a laptop configured to run specialized instructions.

One embodiment of the method for applying a scale to a digital photograph is wherein the data about the subject in a digital photograph relates to non-medical applications such as online sales, site mapping, insurance documentation, digitized inventory, and forensics.

One embodiment of the method for applying a scale to a digital photograph further comprises providing a calibration table identifying size as a function laser-determined distance.

One embodiment of the method for applying a scale to a digital photograph further comprises adding documentation details onto the digital photograph.

One embodiment of the method for applying a scale to a digital photograph is wherein the documentation details are selected from the group consisting of a patient identification number, a date, a time, a body part or region, a distance to a feature, and a scale.

These aspects the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of an illustrative embodiment of the system of the present invention.

FIG. 2 is a schematic diagram of an illustrative embodiment of the system of the present invention with several user interfaces.

FIG. 3 represents an embodiment of the system of the present invention showing a scale applied to a photograph.

FIG. 4 represents an embodiment of the system of the present invention showing a scale applied to a photograph.

FIG. 5 represents an embodiment of the system of the present invention showing an integrated camera and laser for applying a scale to a digital photograph.

### DETAILED DESCRIPTION OF THE INVENTION

The system and method of the present invention comprises a central processor with specialized instructions for configuring a system that associates a length-scale with a photographic image. In certain embodiments, the properties of the system are defined based on user selection according to the particular application of the invention. In certain embodiments, the photographic image relates to non-medical applications including, but not limited to, online sales, site mapping, insurance documentation, digitized inventory, forensics and the like. In certain embodiments, the photographic image relates to medical applications including, but not limited to, diagnoses, wound monitoring, treatment assessment and the like.

It is understood that the method and system described herein could have far-reaching applications. For simplicity, an exemplary application, the monitoring of lymphedema in a patient, will be used to describe the system and method of the present invention. Lymphedema is a condition of localized fluid retention and tissue swelling caused by a compromised lymphatic system. Tissues with lymphedema are at risk of infection and must be monitored over time. In advanced lymphedema, there may be skin changes such as discoloration, increased cell growth, changes in skin thickness and texture, increased skin surface elevation, and deformations to the area of interest. These, and many other visual indicators, can be used to diagnose a condition, to determine whether a particular treatment is effective, and the like.

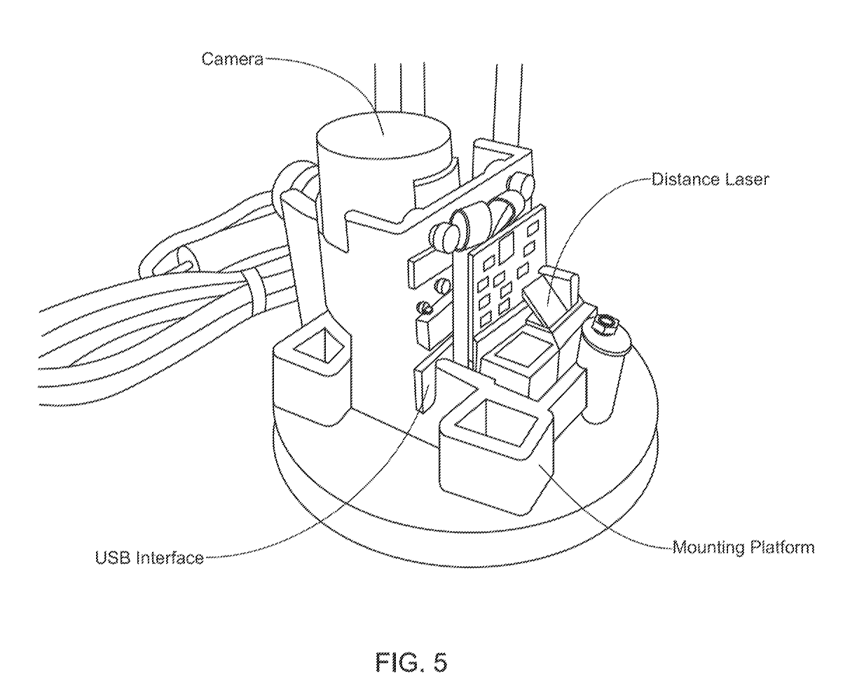

In certain embodiments of the present invention, a length-scale is used to determine the increasing or diminishing size of a photographed feature over time. The system of the present invention is then used to store images and perform select retrieval processes specified by the user. In certain embodiments, when the image is captured, the distance to the photographed object is determined by a laser, and a length-scale is associated with the photographic image. The image and its length scale can then be used to determine the size of the object. In certain embodiments, the laser is a class 2 laser. In certain embodiments, the laser is adjacent to a digital camera. See, for example, FIG. 5. In certain embodiments, the laser and camera are connected to an articulating arm such as a Halux exam light by Derugo Licht AG. In certain embodiments, the laser is integrally connected to the camera.

In certain embodiment's, the image (e.g. of a wound or other feature) is captured with a digital camera operated by a laptop computer configured to run specialized instructions. In certain embodiments, a laser-finder measures the distance to the feature and associates the distance with the digital image. In certain embodiments of the present invention, a scanner is used to gather information relating to the subject of the image. In certain embodiments, the scanner is a bar code scanner. In certain embodiments, the scanner collects information relating to a patient and stores that data with and/or on the digital image. In certain embodiments, the scanner is in electrical connection the central processor.

Once a photograph has been taken of a feature, the distance to the feature at that moment is measured by the laser. In certain embodiments, the user can choose the unit of measurement (e.g., US or metric) and the type of scale (including, but not limited to, horizontal and vertical axes, horizontal axis only, vertical axis only, target-configuration, marginal rulers, and the like). In certain embodiments, the system compares the distance measured with values in a calibration table indicating how many pixels per unit are represented by that distance. In certain embodiments, a corresponding grid is drawn on the photograph.

In certain embodiments, the data collected is stored for later analysis and retrieval. In certain embodiments, the data includes, but is not limited to the distance, the size of the feature, the date, the time, the patient ID, and the like. In certain embodiments of the system and method of the present invention, the scaled photograph is saved to a file system. In certain embodiments, the file system is a HIPAA compliant file system.

In certain embodiments, after clicking on an icon on an initial screen, the user is presented with a window. See, for example, FIG. 2, upper left. In certain embodiments, the initial screen allows the user to scan a patient's wristband or manually enter a file name. In certain embodiments, the system automatically appends the filename with the date and time. In certain embodiments, the time is to the nearest second to ensure that multiple photographs of the same patient (or subject) have unique file names. In certain embodiments, the system blocks any special or invalid characters.

In certain embodiments, once a filename is entered, the central processor automatically presents the user with a clickable anatomical diagram, used to identify the general area of the human body where the photograph will be taken. In certain embodiments, the body-area identified on the diagram briefly changes color to indicate selection. In certain embodiments of the system of the present invention, the screen automatically advances to show the camera's viewpoint.

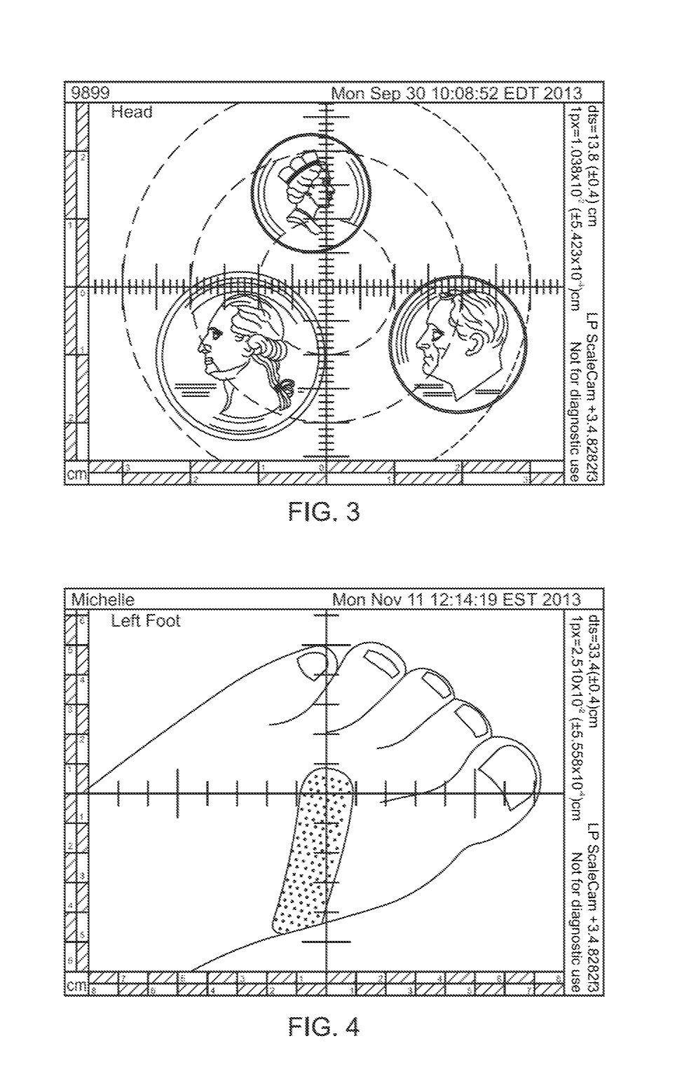

In certain embodiments, the screen showing the cameras viewpoint includes a header identifying the filename, the general body-area, and the current date and time. See, for example, FIG. 3 and FIG. 4. In certain embodiments, the user may observe the screen while moving the camera into position. In certain embodiments, once the camera is in position and the picture is focused, a camera icon appears (See, for example, FIG. 2, left center). In certain embodiments, if the focus is interrupted, the camera icon will be temporarily disabled until the image stabilizes. At this point the camera can be adjusted to achieve optimum focus and the camera icon becomes enabled. In certain embodiments, the user clicks the camera icon to take a photograph and advance to the next screen (See, for example, FIG. 2, lower left). In certain embodiments, the resulting photograph includes a header.

In certain embodiments, the photograph automatically records a file name comprising the patient's ID number, the day, the date and time of the photograph, properties of the grid scale measuring the feature being photographed, information about the particular version of software, and the like.

In certain embodiments, the filename, the body-part information, and the like can be edited with a double click, if necessary. In certain embodiments, users can choose either metric or standard measuring scales in vertical, horizontal, or circular grid-format, for example. In certain embodiments, if the resulting photo is acceptable, the user clicks on a green check mark. In certain embodiments, if the resulting photograph is not acceptable, the user clicks on a red “retake” button to retake the photograph.

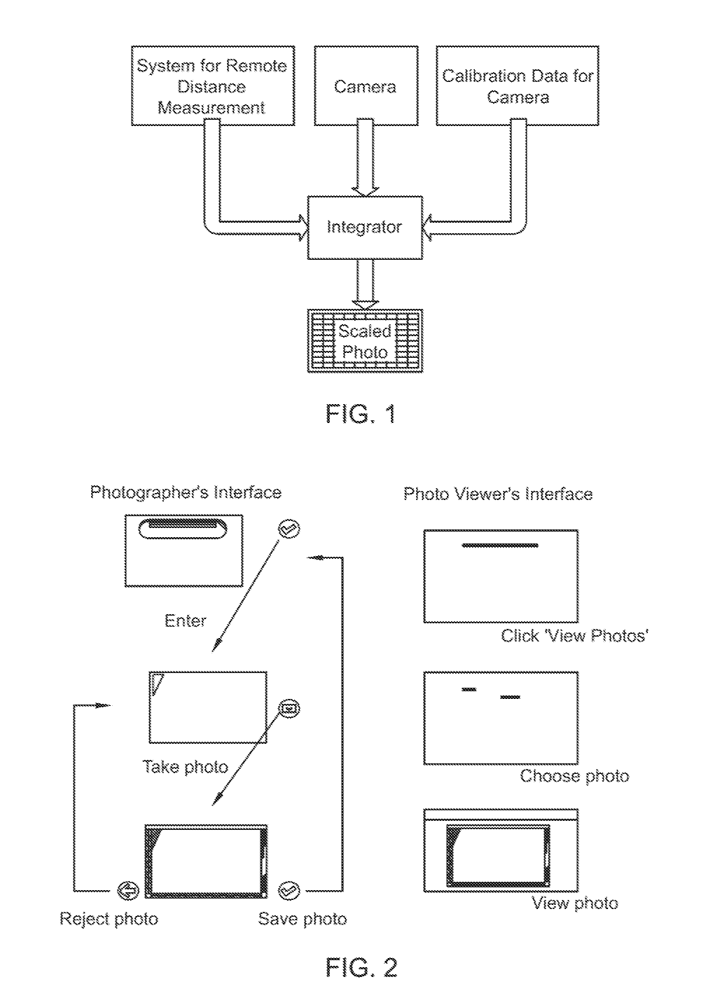

Referring to FIG. 1, a schematic diagram of an illustrative embodiment of the system of the present invention is shown. More particularly, the system of the present invention comprises a system for remote distance measurement, a camera, calibration data for the camera, and an integrator, or central processor. The system of the present invention produces a scaled photograph that can be used in a variety of fields.

Referring to FIG. 2, a schematic diagram of an illustrative embodiment of the system of the present invention with several user interfaces is shown. More particularly, the system of the present invention utilizes specific instruction on a central processor to at least take, save, focus, scale, and view photographs.

Referring to FIG. 3, an embodiment of the system of the present invention showing a scale applied to a photograph is shown. More particularly, the subject here is a series of coins with various data displayed on the photograph visually, and in electronic format. The subject has a scale applied to the photograph to help determine the size of each feature. In certain embodiments, the scale is in centimeters. In certain embodiments, the scale is in inches. In certain embodiments, the scale is in a target configuration. In certain embodiments, the scale is in a grid configuration. In certain embodiments, the scale is in a mesh configuration.

Referring to FIG. 4, an embodiment of the system of the present invention showing a scale applied to a photograph is shown. More particularly, the subject here is the left foot of a patient. In certain embodiments, various documentation details are present on the photograph. In certain embodiments, the subject is a body part and remote measuring is used to provide a series of photographs and to preserve the sterility of an area, while monitoring the progress of a particular treatment or to diagnose a condition.

Referring to FIG. 5, an embodiment of the system of the present invention showing an integrated camera and laser for applying a scale to a digital photograph is shown. More particularly, a mounting platform is shown with a camera attached. In certain embodiments, the system further comprises a light. In certain embodiments, the system further comprises an articulating arm. In certain embodiments, the system further comprises a laser. In certain embodiments, the system further comprises a USB interface. In certain embodiments, the system further comprises a scanner. In certain embodiments, the system further comprises a central processor. In certain embodiments, the system further comprises a display (not shown). In certain embodiments, the distance laser determines a measuring integer that is converted via the USB interface board and sent to the central processor. In certain embodiments, the digital camera sends a photograph of the subject to the central processer running specialized instructions, and the processor takes the information and creates an image with the digital scale overlaid on the image. In certain embodiments, the central processor, using specialized instructions, further processes information relating to the subject, e.g., patient identification number, date, time, and the like, and adds the information to the image for analysis, display and/or storage.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

1. A system for applying a scale to a digital photograph, comprising
a scanner, wherein the scanner is configured to collect data about a subject in a digital photograph;
a digital camera, wherein the digital camera is configured to capture digital photographs of the subject; and
laser adjacent to the digital camera, wherein the laser determines the distance from the subject and uses the distance to apply a scale to the digital photograph;
a central processor in electrical communication with the scanner, the laser, and the digital camera, wherein the processor collects, processes, and stores data relating to the digital photographs.

2. The system for applying a scale to a digital photograph of claim 1, wherein the data about the subject in a digital photograph relates to a patient.

3. The system for applying a scale to a digital photograph of claim 2, wherein the data about the subject in a digital photograph comprises a patient identification number, date, time, and body part.

4. The system for applying a scale to a digital photograph of claim 1, wherein the central processor can be used to select the unit of measurement and the type of scale to be applied to the digital photograph.

5. The system for applying a scale to a digital photograph of claim 1, further comprising an articulating arm connected to the digital camera.

6. The system for applying a scale to a digital photograph of claim 1, wherein the central processor is a laptop configured to run specialized instructions.

7. The system for applying a scale to a digital photograph of claim 1, wherein the data about the subject in a digital photograph relates to non-medical applications such as online sales, site mapping, insurance documentation, digitized inventory, and forensics.

8. A method of applying a scale tip to a digital photograph, comprising
providing a scanner, wherein the scanner is configured to collect data about a subject in a digital photograph;
providing a digital camera, wherein the digital camera is configured to capture digital photographs of the subject in a digital photograph; and
providing a laser adjacent to the digital camera;
determining, with the laser, the distance from the subject;
applying a scale to the digital photograph;
providing a central processor in electrical communication with the scanner, the laser, and the digital camera;
collecting data relating to the digital photographs;
processing data relating to the digital photographs; and
storing data relating to the digital photographs.

9. The method for applying a scale to a digital photograph of claim 8, wherein the data about the subject in a digital photograph relates to a patient.

10. The method for applying a scale to a digital photograph of claim 9, wherein the data about the subject in a digital photograph comprises a patient identification number, date, time, and body part.

11. The method for applying a scale to a digital photograph of claim 8, wherein the central processor can be used to select the unit of measurement and the type of scale to be applied to the digital photograph.

12. The method for applying a scale to a digital photograph of claim 8, further comprising providing an articulating arm connected to the digital camera.

13. The method for applying a scale to a digital photograph of claim 8, wherein the central processor is a laptop configured to run specialized instructions.

14. The method for applying a scale to a digital photograph of claim 8, wherein the data about the subject in a digital photograph relates to non-medical applications such as online sales, site mapping, insurance documentation, digitized inventory, and forensics.

15. The method for applying a scale to a digital photograph of claim 8, further comprising providing a calibration table identifying size as a function of laser-determined distance.

16. The method for applying a scale to a digital photograph of claim 8, further comprising adding documentation details onto the digital photograph.

17. The method for applying a scale to a digital photograph of claim 16, wherein the documentation details are selected from the group consisting of a patient identification number, a date, a time, a body part or region, a distance to a feature, and a scale.
